(19) United States
(12) Patent Application Publication
(10) Pub. No.: US 2025/0266958 A1
(43) Pub. Date: Aug. 21, 2025

(54) SOLUTION FOR MANAGEMENT OF SOUNDING REFERENCE SIGNALS

(71) Applicant: Telefonaktiebolaget LM Ericsson (publ), Stockholm (SE)

(72) Inventors: Zhiming YIN, DANDERYD (SE); Magnus HURD, STOCKHOLM (SE)

(73) Assignee: Telefonaktiebolaget LM Ericsson (publ), Stockholm (SE)

(21) Appl. No.: 18/859,380

(22) PCT Filed: Apr. 26, 2022
(86) PCT No.: PCT/SE2022/050402

§ 371 Date: Oct. 23, 2024

(51) Int. Cl. H04L 5/00

(52) U.S. Cl. CPC H04L 5/0051

(57) ABSTRACT

A method (700) performed by a UE (102). The method includes receiving first sounding reference signal, SRS, configuration information, SRS-CI, the first SRS-CI comprising: first SRS resource information, SRS-RI, associated with a first beam and second SRS-RI associated with a second beam, wherein the first SRS-RI specifies a first periodicity and the second SRS-RI specifies a second periodicity that is longer than the first periodicity. The method also includes transmitting to a serving base station (104) a first plurality of SRSs in accordance with the first periodicity specified by the first SRS-RI. The method also includes transmitting to the serving base station a second plurality of SRSs in accordance with the second periodicity specified by the second SRS-RI.

### TECHNICAL FIELD

Disclosed are embodiments related to sounding management.

### BACKGROUND

Highband deployment by a network is referred to by the 3rd Generation Partnership Project (3GPP) as deployment on frequencies higher than 6 GHz. To cope with the coverage challenge at these high frequencies more antenna elements are needed. In New Radio (NR) the notion of massive antenna arrays has been introduced to achieve both increased coverage and increased level of throughput. These antenna arrays are sometimes referred to as Advanced Antenna Systems (AAS). In 3GPP the AAS is referred to as a Transmission/Reception Point (TRP) and is simply a collection of antenna elements, like a panel of elements. To reduce the cost of an AAS, analog beamforming may be used. Also, at the user equipment (UE) side, analog beamforming is expected for highband deployment; which means the UE can only receive a transmission from one beam at a time because its spatial reception filter applies to all resource elements of an Orthogonal Frequency Division Multiplexing (OFDM) symbol (per polarization). Typically for highband deployment, bands are TDD.

Analog beamforming is an example of time-domain beamforming, meaning one beamform applies to all frequency resources being part of a transmission from the base station. Hybrid beamforming based on different sub-arrays of antenna elements connected to separate RF chains is another version of time-domain beamforming. Compared to strict digital beamforming, hybrid beamforming can be seen as the digital domain operating an array of subarrays of antennas. The subarrays of antennas are subject to analog beamforming and act as physical antennas except that the beamforms of the subarrays can each be pointing in different directions given appropriate analog weights for a specific point in time. Here we refer to these sub-arrays as analog antenna subarrays.

Theoretically, the analog beamforms of the analog antenna subarrays can point in different directions; however, a typical deployment would have these beamforms targeting similar directions. This translates into analog weights that are same (or close to) for the different analog antenna subarrays that the digital domain operates (typically coordinating the different subarrays to form a phased array). This should not be too surprising: a strict digital system connected to an array of physical antennas would generally utilize antennas with identical beamforms, not different antennas with beamforms pointing in different directions, simply to more easily coordinate the beamforms of the individual antennas. The overall objective of the analog beams to point in the same direction is to have them coherently combine for extended coverage range. This means that this variant of hybrid beamforming executes digital service within one analog beamform created by the analog antenna subarrays at a time.

To properly schedule a UE with air interface resources, the base station serving the UE needs to know the beam of the analog antenna subarrays to which the UE “belongs” (i.e., which beam covers the UE). Essentially, the predicted performance of the current serving analog beam needs to be compared with the predicted performance of all the other candidate analog beams. There are several ways of doing this; one approach uses sounding.

In 3GPP terminology, sounding involves a UE transmitting Sounding Reference Signals (SRSs) (see, e.g., 3GPP Technical Specification TS 38.211 v17.1.0 (“TS 38.211”)). The SRS transmitted by the UE is a specifically defined reference signal received by the base station, repeatedly using each beam (of the analog antenna subarrays) applicable for the intended coverage area. There could be a number of these beams; therefore, the UE needs to transmit SRS on several symbols such that the base station can receive on some symbols using a certain beam until SRS has been received on all beams considered relevant for the UE. The base station allocates SRS resources individually for each UE.

The UEs are provided with SRS resources orthogonal to each other, meaning they are differentiated with respect to frequency (resource blocks and comb pointing out specific subcarriers) and cyclic shift (maximum 12). The cyclic shift is a way to share a range of subcarriers: a sequence of complex phases is applied to the subcarriers (as a function of subcarrier index); each UE would have different sequences (loosely referred to as different cyclic shifts) to share the frequency resources. All in all, the aspect that each UE is provided with an individual resource means that there will always be a limit on how many SRS resources can be allocated at any given time.

Sounding is not only used for tracking which analog beam a UE is located within, but also used for detailed estimation of the channel within the current serving beam. This enables transmissions in regard to selected modulation, code rate, and number of layers. Generally, this estimation needs to happen frequently enough to follow the channel. Sounding for the purpose of beam tracking is expected to be less frequent.

### SUMMARY

Certain challenges presently exist. For instance, a method relying on channel state information (CSI) reports based on measuring a CSI reference signal (CSI-RS) or other signal to identify what analog beam a UE belongs to is costly with regard to uplink resources because the CSI report potentially adds load to the physical uplink control channel (PUCCH) and/or the physical uplink shared channel (PUSCH). Additionally, a method based on allocating SRS resources to UEs in a deployment using hybrid beamforming such that all candidate beams are probed as often as the serving beam is not resource-efficient because, as new UEs enter a cell served by a base station, these new UEs are provided with SRS resources such that reception on all analog beams can happen and because an analog beam applies to all frequency resources, the base station needs to allocate one symbol for each analog beam. Typically there are many UEs within the coverage area of the base station, and each of these UEs will need, for each beam defined for the base station, an SRS resource corresponding to the beam. Because there is a finite number of SRS resources available at any point in time (e.g., in one symbol), only a limited number of UEs are assigned SRS resources in each symbol. It is this limited number of SRS resources that is a problem in scenarios with many users.

Accordingly, in one aspect there is provided a method performed by a UE. The method includes receiving first sounding reference signal, SRS, configuration information, SRS-CI, the first SRS-CI comprising: first SRS resource information, SRS-RI, associated with a first beam and second SRS-RI associated with a second beam, wherein the first SRS-RI specifies a first periodicity and the second SRS-RI specifies a second periodicity that is longer than the first periodicity. The method also includes transmitting to a serving base station a first plurality of SRSs in accordance with the first periodicity specified by the first SRS-RI. The method also includes transmitting to the serving base station a second plurality of SRSs in accordance with the second periodicity specified by the second SRS-RI.

In another aspect there is provided a computer program comprising instructions which when executed by processing circuitry of a UE causes the UE to perform any of the UE methods disclosed herein. In one embodiment, there is provided a carrier containing the computer program wherein the carrier is one of an electronic signal, an optical signal, a radio signal, and a computer readable storage medium. In another aspect there is provided a UE that is configured to perform the UE methods disclosed herein. The UE may include memory and processing circuitry coupled to the memory.

In another aspect there are methods performed by a base station. In one embodiment the method includes transmitting to a UE first SRS-CI, the first SRS-CI comprising: first SRS-RI associated with a first beam and second SRS-RI associated with a second beam, wherein the first SRS-RI specifies a first periodicity and the second SRS-RI specifies a second periodicity that is longer than the first periodicity. The method also includes receiving a first plurality of SRSs transmitted by the first UE in accordance with the first periodicity specified by the first SRS-RI. The method further includes receiving a second plurality of SRSs transmitted by the first UE in accordance with the second periodicity specified by the second SRS-RI.

In another embodiment the method performed by the base station includes, during a first period of time, transmitting to a first user equipment, UE, at least a first number, N1, of command messages, wherein each one of the N1 command messages triggers the UE to transmit a sounding reference signal, SRS, using a resource associated with a first beam. The method also includes, during said first period of time, transmitting to the first UE, not more than a second number, N2, of command messages, wherein each one of the N2 command messages triggers the UE to transmit an SRS using a resource associated with a second beam, wherein N1>N2.

In another aspect there is provided a computer program comprising instructions which when executed by processing circuitry of a base station causes the base station to perform any of the base station methods disclosed herein. In one embodiment, there is provided a carrier containing the computer program wherein the carrier is one of an electronic signal, an optical signal, a radio signal, and a computer readable storage medium. In another aspect there is provided a base station that is configured to perform the methods disclosed herein. The base station may include memory and processing circuitry coupled to the memory.

An advantage of the embodiments disclosed herein is that they enable resource-efficient allocation of SRS resources, thereby enabling higher uplink throughput.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 illustrates an SRS configuration according to an embodiment.

FIG. 3 illustrates an SRS configuration according to an embodiment.

FIG. 4 illustrates an SRS configuration according to an embodiment.

FIG. 5 illustrates an SRS configuration according to an embodiment.

FIG. 6 illustrates an SRS configuration according to an embodiment.

FIG. 7 is a flowchart illustrating a process according to an embodiment.

FIG. 8 is a flowchart illustrating a process according to an embodiment.

FIG. 9 is a flowchart illustrating a process according to an embodiment.

FIG. 10 is a block diagram of an UE according to an embodiment.

FIG. 11 is a block diagram of a base station according to an embodiment.

### DETAILED DESCRIPTION

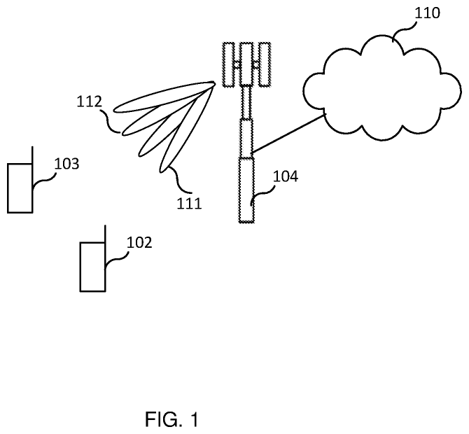

FIG. 1 illustrates a system 100 according to an embodiment. System 100 includes a base station 104 that enables UEs (e.g., UE 102 and UE 103) to access a network 110 (e.g., the Internet). As used herein, a base station is any device (e.g., 3GPP base station, WiFi access point, etc.) that wirelessly communicates with a UE to provide network access to the UE. As used herein, a UE is any device capable of wireless communication with base station 104. Base station 104 uses hybrid beamforming to communicate with the UEs that it serves. In the example shown, beam 111 is the serving beam for UE 102 and beam 112 is the serving beam for UE 103. Hence, beam 112 is a candidate beam for UE 102, while beam 111 is a candidate beam for UE 102. If UE 102 moves to (or close to) the UE 103, then base station 104 will switch the serving beam for UE 102 so that beam 112 will become the new serving beam for UE 102. Base station 104 can detect such movement by configuring UE 102 to transmit SRSs for at least beams 111 and 112.

As noted above, certain challenges presently exist. For instance, because there is a finite number of SRS resources available at any point in time, only a limited number of UEs are assigned SRS resources in each symbol. This limited number of SRS resources can be a problem in scenarios with many UEs because not all UEs will be granted a sufficient amount of SRS resources.

Accordingly, this disclosure proposes using SRS resources such that the serving beam for a particular UE (e.g., beam 111 for UE 102) is probed more often than one or more candidate beams for the UE (e.g., beam 112 for UE 102). This means that the UE will use fewer SRS resources, thereby freeing these SRS resources for use by other UEs served by base station 104.

In one embodiment, when UE 102 moves into the coverage area of base station 104, UE 102 is configured with SRS resources for all analog beams that expect to serve the UE in the cell. This means the UEs served by base station 104 share configured SRS resources, but the base station 104 will coordinate SRS transmissions such that only one UE at a time is configured to transmit on a given SRS resource (regardless of whether other UEs have also been configured with the same resources).

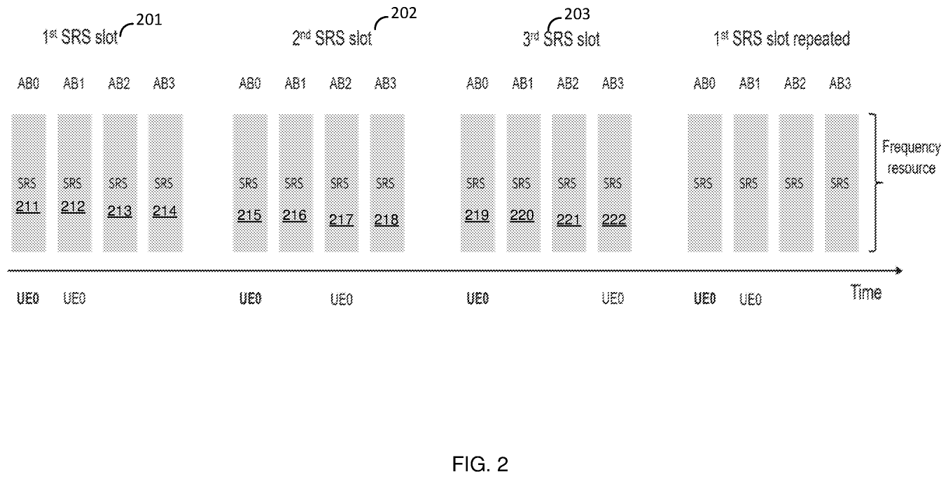

FIG. 2 illustrates an SRS configuration intended to be used by a UE (hereafter “UE0”) served by base station 104. This SRS configuration is indicated to the UE by means of a Radio Resource Control (RRC) configuration. As illustrated in FIG. 2, SRS resources for analog beam 0 (AB0) (the current serving beam for UE0) is measured more often and SRS resources for adjacent beams are measured less often. The frequency for measuring SRS resource for one analog beam is related to how likely the UE is expected to move to that beam: less likely beams are measured less often. How likely a candidate beam is expected to become the next serving beam can be estimated based on the sounding measurement; if the sounding measurement of the candidate beam represents a signal comparable to the serving beam, then one may increase the frequency for this candidate beam. The sounding measurement could simply be received power (e.g., reference signal received power (RSRP)), such that an analog beam with more received power (more likely to be next serving beam) is sounded more often. As time goes by, the base station can collect all these measurements over time to optimize the configured frequency of candidate beam sounding such that for one specific serving beam the frequency of the candidate beams is according to the average of historical sounding measurements.

In the example shown in FIG. 2, analog beam 0 (AB0) (the current serving beam) is measured in all of the SRS slots because this beam is considered to remain as the serving beam (moreover the details of the channel in the serving beam need to be determined with high enough confidence) (this is illustrated in FIG. 2 by the bolding of UE0 underneath the SRS resources 211, 215, and 219 associated with AB0); the adjacent beams in this example (AB1, AB2, and AB3) are considered equally likely, and each of them are measured on a subset of the SRS slots because they are all considered as less likely to be the next beam as compared to AB0. More specifically, as illustrated in FIG. 2, during the first slot 201, the UE (denoted UE0) transmits an SRS using an SRS resource 211 associated with AB0 and transmits an SRS using an SRS resource 212 associated with AB1, but does not transmit any SRS using SRS resources 213 and 214 associated with AB2 and AB3, respectively. During the second slot 202, the UE (denoted UE0) transmits an SRS using an SRS resource 215 associated with AB0 and transmits an SRS using an SRS resource 217 associated with AB2, but does not transmit any SRS using SRS resources 216 and 218 associated with AB1 and AB3, respectively. During the third slot 203, the UE (denoted UE0) transmits an SRS using an SRS resource 219 associated with AB0 and transmits an SRS using an SRS resource 222 associated with AB3, but does not transmit any SRS using SRS resources 220 and 221 associated with AB1 and AB2, respectively. After the third slot 203 the cycle repeats. It should be noted that the SRS slot is just an example, because AB0/AB1/AB2/AB3 do not have to be in one slot and they can be in different slots.

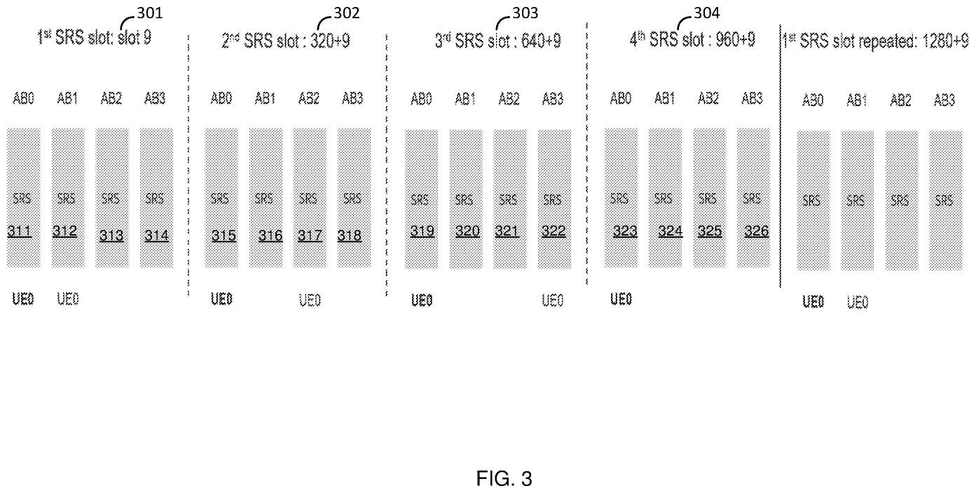

Generally, an SRS resource is configured to repeat at a certain periodicity together with an offset as described by the parameter SRS-Periodicity AndOffset (see 3GPP TS 38.331 v16.7.0 (hereafter “TS 38.331”)). Optimally one would have a periodicity aligned with the number of analog beams to probe, but sometimes that is not possible due to limited parameter options. In FIG. 3, a case is shown when the candidate beams are probed each 4^{th} SRS slot (instead of each 3^{rd} SRS slot) due to limitations of the available options for SRS-Periodicity AndOffset. More specifically, as illustrated in FIG. 3, during the first slot 301, the UE (denoted UE0) transmits an SRS using an SRS resource 311 associated with AB0 and transmits an SRS using an SRS resource 312 associated with AB1, but does not transmit any SRS using SRS resources 313 and 314 associated with AB2 and AB3, respectively. During the second slot 302, the UE transmits an SRS using an SRS resource 315 associated with AB0 and transmits an SRS using an SRS resource 317 associated with AB2, but does not transmit any SRS using SRS resources 316 and 318 associated with AB1 and AB3, respectively. During the third slot 303, the UE transmits an SRS using an SRS resource 319 associated with AB0 and transmits an SRS using an SRS resource 322 associated with AB3, but does not transmit any SRS using SRS resources 320 and 321 associated with AB1 and AB2, respectively. During the fourth slot 304, the UE transmits an SRS using an SRS resource 323 associated with AB0, but does not transmit any SRS using SRS resources 324, 325, and 326 associated with AB1, AB2 and AB3, respectively. After the fourth slot 304 the cycle repeats.

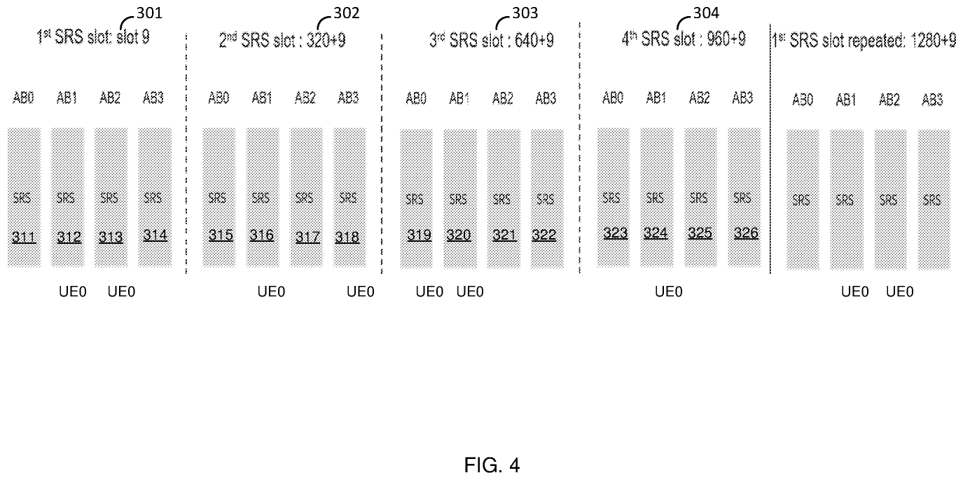

UE0 may move to one of the candidate beams, and, when this happens, the candidate beam will become the serving beam and a different layout of the configured SRS resources would apply, as shown in tted UE1, which shows that UE0 has moved from AB0 to AB1. Now it is AB1 that is measured more often and the adjacent beams less often. It could also apply to a newly admitted UE1. Corresponding SRS configurations exist also for when UE0 is located in AB2 and AB3. The same principle applies: the serving beam is measured more often and the adjacent beams less often. More specifically, as illustrated in FIG. 4, during the first slot 301, the UE (denoted UE0) transmits an SRS using an SRS resource 312 associated with AB1 and transmits an SRS using an SRS resource 313 associated with AB2, but does not transmit any SRS using SRS resources 311 and 314 associated with AB0 and AB3, respectively. During the second slot 302, the UE transmits an SRS using an SRS resource 316 associated with AB1 and transmits an SRS using an SRS resource 318 associated with AB3, but does not transmit any SRS using SRS resources 315 and 317 associated with AB0 and AB2, respectively. During the third slot 303, the UE transmits an SRS using an SRS resource 319 associated with AB0 and transmits an SRS using an SRS resource 320 associated with AB0, but does not transmit any SRS using SRS resources 321 and 322 associated with AB2 and AB3, respectively. During the fourth slot 304, the UE transmits an SRS using an SRS resource 324 associated with AB1, but does not transmit any SRS using SRS resources 323, 325, and 326 associated with AB0, AB2 and AB3, respectively. After the fourth slot 304 the cycle repeats.

The SRS configurations described above are provided to the UE using RRC configuration as defined in TS 38.331. This means the UE already from the start is prepared with all configurations for the event of moving from one analog beam to another. It is only a matter of the base station informing the UE about which of the SRS resources to actually use, using one of the following methods: (i) a Media Access Control (MAC) Control Element (MAC-CE) (described in clause 6.1.3.26 of 3GPP TS 38.321 v16.7.0 (hereafter “TS 38.321”)) for the case of semipersistent SRS or (ii) indication in a downlink (DL) or an uplink (UL) Downlink Control Information (DCI) as part of a PDCCH for the case of aperiodic SRS. For aperiodic SRS, the periodicity of the SRS transmission is not applicable because the transmission only happens as a single event; instead it is the base station 104 that needs to request aperiodic SRS using the MAC-CE or DCI according to a periodic schedule. A third method would be to use periodic SRS, in which case one needs rely on RRC reconfiguration to change SRS transmission whenever the UE moves to another analog beam.

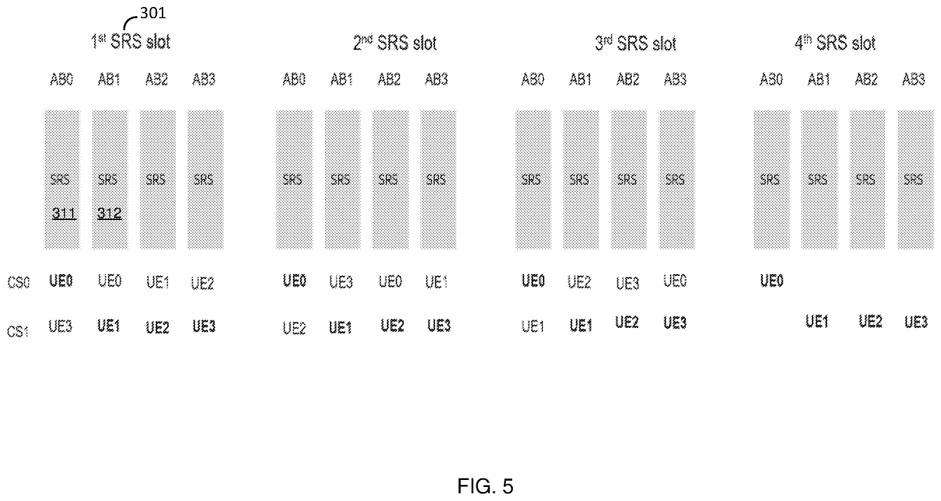

FIG. 5 show how the SRS configurations described above allow more UEs to be allocated on a given amount of SRS resources. That is, FIG. 5 shows packing of UEs onto two SRS resources per symbol (each with different cyclic shift). More specifically, for example, FIG. 5 shows that during the first slot 301 both UE0 and UE3 transmit an SRS using SRS resource 311, but UE0 transmits the SRS using a specific cyclic shift (CS0) and UE3 transmits the SRS using a different specific cyclic shift (CS1). Likewise, during the first slot 301 both UE0 and UE1 transmit an SRS using SRS resource 312, but UE0 transmits the SRS using cyclic shift CS0 and UE1 transmits the SRS using cyclic shift CS1.

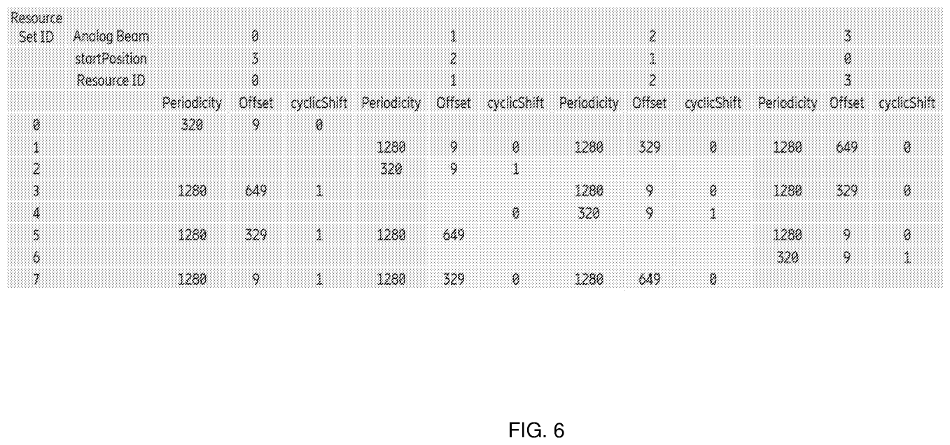

All the UEs in FIG. 5 (i.e., UE0, UE1, UE2, and UE3) share the same frequencies, meaning they have same configured values for transmissionComb, combOffset and freqDomainShift in regard to their SRS configurations. They only differ with respect to cyclic shift. An example how sounding is organized with respect to SRS resource sets, SRS resources, periodicity, offset, cyclic shift, startposition (symbol in the slot; startposition 0 refers to symbol 13 or last symbol in a slot and startposition 3 refers to symbol 10) and analog beams are shown in FIG. 6 (configuration covering all locations for a UE). Some renaming in regard to RRC parameter names are used to fit into a figure: Resource Set ID corresponds to srs-ResourceSetId, Resource ID corresponds to srs-ResourceId, Periodicity and Offset are both derived from periodicity AndOffset-sp, cyclicShift corresponds to cyclicShift-n2 or cyclicShift-n4; the other names are unchanged)

Resource set ID 0 and 1 apply when the UE is located in AB0, resource set ID 2 and 3 apply when the UE is located in AB1, and so on so forth. The base station may configure each admitted UE (i.e., the UEs that it serves) with the configuration shown in FIG. 6. This way each served UE is prepared to transmit an SRS even if the UE moves to another analog beam. If more than one UE seeks to be admitted to the same analog beam, the base station configures this UE with resources as in FIG. 5, but with different frequency resources as represented by transmissionComb, combOffset and freqDomainShift. In FIG. 6, the SRS resources are organized into resources sets according to UE location.

For example, the activated RRC configuration for UE0 may be as follows (the configuration for AB1, AB2 and AB3 same as AB0 is omitted for simplicity). There are other configuration options, and the idea is not limited to this example.

TABLE 1
Example SRS configuration information
(SRS-CI) provided to a UE

```
SRS-ResourceSet
srs-ResourceSetId = 0
srs-ResourceIdList = {0}
resourceType = semi-persistent
SRS-Resource (for UE0 when AB0 is serving beam)
srs-ResourceId = 0
transmissionComb = n4
  combOffset = 0
  cyclicShift = 0
resourceMapping
```

| | |
|---|---|
| startPosition = 3 | (symbol 10 in the slot) |
| nrofSymbols = n1 | (1 symbol) |

freqDomainShift =0
resourceType = semi-persistent

| | |
|---|---|
| SRS-PeriodicityAndOffset = sl320 (9) | (every 40ms, slot 9) |

SRS-ResourceSet
srs-ResourceSetId = 1
srs-ResourceIdList = {1, 2, 3}
resourceType = semi-persistent
SRS-Resource (for UE0 when AB1 is candidate beam)
srs-ResourceId = 1
resourceMapping

| | |
|---|---|
| startPosition = 2 | (symbol 11 in the slot) |
| SRS-PeriodicityAndOffset = sl1280 (9) | (every 160ms, slot 9) |

SRS-Resource (for UE0 when AB2 is candidate beam)
srs-ResourceId = 2
resourceMapping

| | |
|---|---|
| startPosition = 1 | (symbol 12 in the slot) |
| SRS-PeriodicityAndOffset = sl1280 (329) | (every 160ms, slot 329) |

SRS-Resource (for UE0 when AB3 is candidate beam)
srs-ResourceId = 3
resourceMapping

| | |
|---|---|
| startPosition = 0 | (symbol 13 in the slot) |
| SRS-PeriodicityAndOffset = sl1280 (649) | (every 160ms, slot 649) |

That is, in one example, base station 104 transmits to UE 102 an RRC message comprising the SRS configuration information shown in the table above.

The packing of UEs may lead to competition for SRS resources when UEs move from one analog beam to another where sounding resources are exhausted. A straightforward approach is to accept the limited resource situation and have this UE sound less often until another UE of the same serving beam moves away to another beam. One may also define extra SRS resources for temporary use for these mobility cases; these special resources are only used by UEs already admitted to the cell, not for UEs performing handover from another cell. This way of over-allocation resources reduces the risk of a UE moving from one beam to another not being able to sound as often as intended. If one expects much UE mobility in a cell then one would set aside more of these special resources, otherwise less.

The base station 104 needs to consider limitations in regard to how many resources are defined for one UE. Such limitations are stated in 38.331 and for release 16 they are (not exclusively): maxNrofSRS-ResourceSets (16; Maximum number of SRS resource sets in a Bandwidth Part); maxNrofSRS-Resources (64; Maximum number of SRS resources); and maxNrofSRS-ResourcesPerSet (16; Maximum number of SRS resources in an SRS resource set).

The procedures described above take place within one base station. They can be complemented by procedures considering interference from other base stations.

Above it is described how SRS periodicity can be chosen based on received power. Another method is to focus on beam changes. SRS measurement is used for beam management (in other words, keeping track of beam mobility). One method is to record the minimum or average beam change interval within a recent measurement time period or measurement time window, and to choose a periodicity one step or a few steps smaller than the recorded beam change interval. The change interval is simply the time between consecutive changes of the analog beam the UE is located in. For example, if the recorded beam change intervals for the last five beam changes are {320, 640, 1280, 640, 320} slots, the minimum beam change interval is 320 slots and the average beam change interval is 640 slots. A more general way is to use weighted average value of the interval samples and higher weights could be given to more recent samples to show that more recent interval samples are more important than earlier samples. The minimum interval and average interval methods are two special forms of the general method. When the minimum beam change interval is used, the SRS periodicity 160 could be chosen, and when the average beam change interval is used, the SRS periodicity 320 could be chosen. The selected SRS periodicity should be smaller than the measured beam change interval or else higher frequency of beam change cannot be tracked. A maximum SRS periodicity should be configured in order not to lose track of beam change also for the case when there is no beam change in recent history, for example it could be hundreds of milliseconds. A few multiples of the maximum SRS periodicity could be used for the recent measurement time window. Longer measurement window may consume more system resources and SRS resources; due to shorter SRS periodicity it may have better beam change performance.

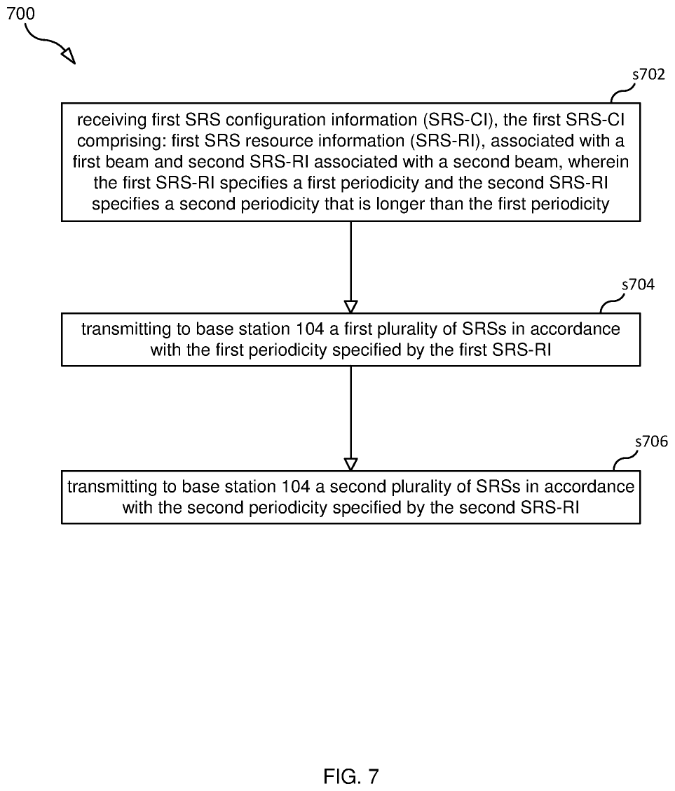

FIG. 7 is a flow chart illustrating a process 700, according to an embodiment. Process 700 is performed by UE 102. Process 700 may begin in step s702. Step s702 comprises receiving first SRS configuration information (SRS-CI), the first SRS-CI comprising: first SRS resource information (SRS-RI), associated with a first beam and second SRS-RI associated with a second beam, wherein the first SRS-RI specifies a first periodicity and the second SRS-RI specifies a second periodicity that is longer than the first periodicity. Step s704 comprises transmitting to base station 104 (a.k.a., “the serving base station”) a first plurality of SRSs in accordance with the first periodicity specified by the first SRS-RI. Step s706 comprises transmitting to base station 104 a second plurality of SRSs in accordance with the second periodicity specified by the second SRS-RI.

In some embodiments, the first beam is a serving beam (i.e., the serving base station 104 is actively using the first beam to communicate with the UE), and the second beam is a candidate beam (i.e., the serving base station 104 is not actively using the first beam to communicate with the UE).

In some embodiments, the first SRC-CI further comprises a third SRS-RI associated with a third beam, and the third SRS-RI specifies a third periodicity. In some embodiments, the third periodicity is longer than the first periodicity. In some embodiments, the third periodicity is equal to the second periodicity (in other embodiments the periodicities are not the same).

In some embodiments, the second periodicity is a function of a probability that the UE will move to within a coverage of the second beam.

In some embodiments, the second periodicity is a function of a measurement of an SRS transmitted by the UE and received by base station 104 using the second beam.

In some embodiments the first SRS-CI specifies that the first SRS-RI is included in a first SRS resource set and the first SRS-CI specifies that the second SRS-RI is included in a second SRS resource set. In some embodiments, the process also includes, after receiving the first SRS-CI and before transmitting the first and second plurality of SRSs, i) receiving a first command message transmitted by the serving base station, wherein the first command message includes a first SRS resource set identifier that identifies the first SRS resource set, and ii) receiving a second command message transmitted by the serving base station, wherein the second command message includes a second SRS resource set identifier that identifies the second SRS resource set, wherein the transmitting steps are performed as a result of receiving the first and second command messages, respectively.

In some embodiments the process also includes receiving second SRS-CI, the second SRS-CI comprising: third SRS-RI associated with the first beam and fourth SRS-RI associated with the second beam, wherein the third SRS-RI specifies a third periodicity and the fourth SRS-RI specifies a fourth periodicity that is shorter than the third periodicity, and the second SRS-CI specifies that i) the third SRS-RI is included in a third SRS resource set and ii) the fourth SRS-RI is included in a fourth SRS resource set.

In some embodiments the process also includes, after receiving the first and second SRS-CI and after transmitting the first and second plurality of SRSs, receiving a third command message transmitted by the serving base station, wherein the third command message includes a third SRS resource set identifier that identifies the third SRS resource set, and receiving a fourth command message transmitted by the serving base station, wherein the fourth command message includes a fourth SRS resource set identifier that identifies the fourth SRS resource set; in response to receiving the third command message, transmitting to the serving base station an SRS using a resource specified by the third SRS-RI; and in response to receiving the fourth command message, transmitting to the serving base station an SRS using a resource specified by the fourth SRS-RI.

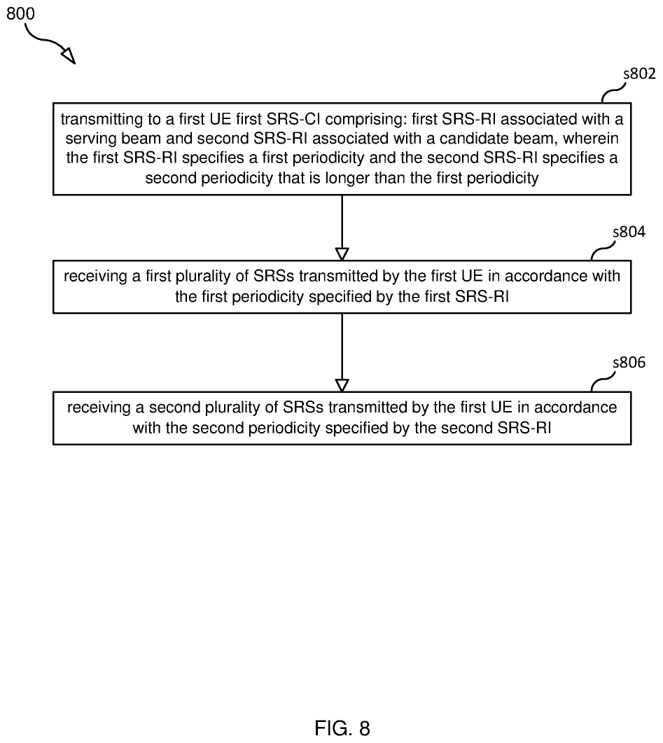

FIG. 8 is a flow chart illustrating a process 800, according to an embodiment. Process 800 is performed by base station 104. Process 800 may begin in step s802. Step s802 comprises transmitting to a first UE (e.g., UE 102) first SRS-CI, the first SRS-CI comprising: first SRS-RI associated with a serving beam (e.g., beam 111) and second SRS-RI associated with a candidate beam (e.g., beam 112), wherein the first SRS-RI specifies a first periodicity and the second SRS-RI specifies a second periodicity that is longer than the first periodicity. Step s804 comprises receiving a first plurality of SRSs transmitted by the first UE in accordance with the first periodicity specified by the first SRS-RI. Step s806 comprises receiving a second plurality of SRSs transmitted by the first UE in accordance with the second periodicity specified by the second SRS-RI.

In some embodiments, transmitting the first SRS-CI to the first UE comprises transmitting to the first UE a control message that comprises the first SRS-CI. In some embodiments, the control message further comprises second SRS-CI, the second SRS-CI comprising: third SRS-RI associated with the first beam and fourth SRS-RI associated with the second beam, wherein the third SRS-RI specifies a third periodicity that is equal to the second periodicity and the fourth SRS-RI specifies the fourth periodicity that is equal to the first periodicity, the first SRS-CI specifies that the first SRS-RI is included in a first SRS resource set, the first SRS-CI specifies that the second SRS-RI is included in a second SRS resource set, the second SRS-CI specifies that the third SRS-RI is included in a third SRS resource set, the second SRS-CI specifies that the fourth SRS-RI is included in a fourth SRS resource set.

In some embodiments the process 800 also includes, after receiving the second plurality of SRSs transmitted by the first UE in accordance with the second periodicity specified by the second SRS-RI, selecting the second beam to be a serving beam for the first UE; and as a result of selecting the second beam to be the serving beam for the first UE, i) triggering the first UE to transmit SRSs in accordance with the third SRS-RI by transmitting to the first UE a first command message that includes an SRS resource set identifier that identifies the third SRS resource set and ii) triggering the first UE to transmit SRSs in accordance with the fourth SRS-RI by transmitting to the first UE a second command message that includes an SRS resource set identifier that identifies the fourth SRS resource set.

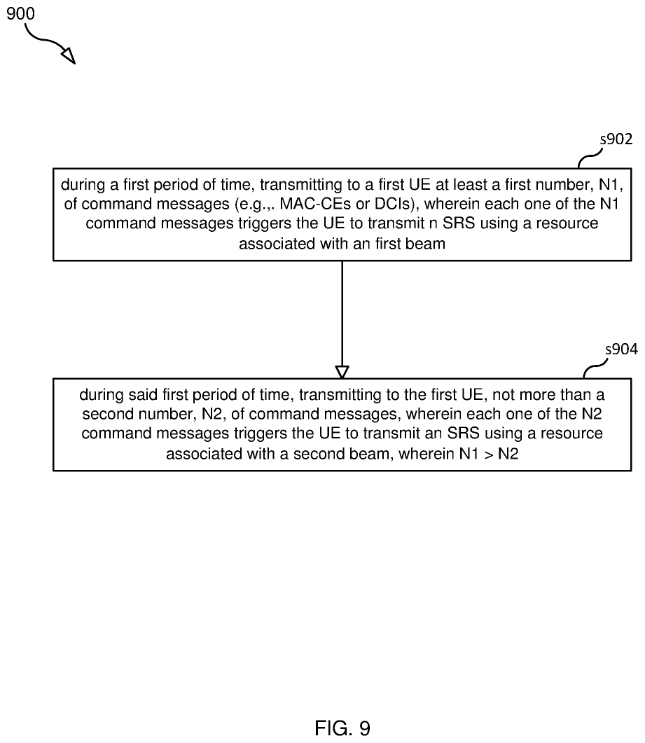

FIG. 9 is a flow chart illustrating a process 900, according to an embodiment for aperiodic SRS. Process 900 is performed by base station 104. Process 900 may begin in step s902. Step s902 comprises during a first period of time, transmitting to a first UE (e.g., UE 102) at least a first number, N1, of command messages (e.g., MAC-CEs or DCIs), wherein each one of the N1 command messages triggers the UE to transmit a sounding reference signal, SRS, using a resource associated with a first beam of base station 104. Step s904 comprises, during said first period of time, transmitting to the first UE, not more than a second number, N2, of command messages, wherein each one of the N2 command messages triggers the UE to transmit an SRS using a resource associated with a candidate beam of base station 104, wherein N1>N2.

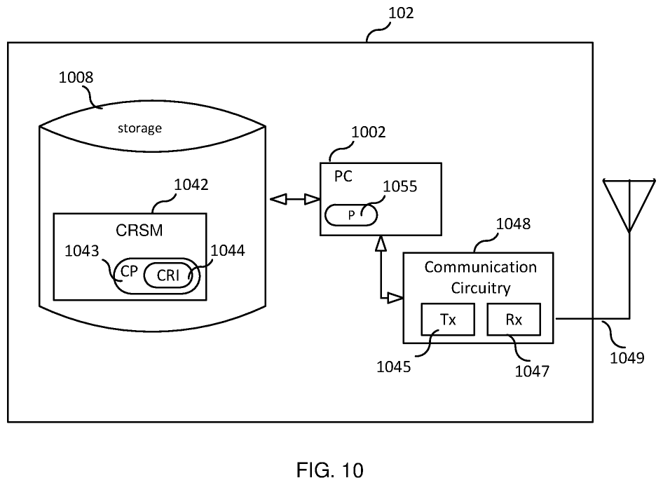

FIG. 10 is a block diagram of UE 102, according to some embodiments. As shown in FIG. 10, UE 102 may comprise: processing circuitry (PC) 1002, which may include one or more processors (P) 1055 (e.g., one or more general purpose microprocessors and/or one or more other processors, such as an application specific integrated circuit (ASIC), field-programmable gate arrays (FPGAs), and the like); communication circuitry 1048, which is coupled to an antenna arrangement 1049 comprising one or more antennas and which comprises a transmitter (Tx) 1045 and a receiver (Rx) 1047 for enabling UE 102 to transmit data and receive data (e.g., wirelessly transmit/receive data); and a storage unit (a.k.a., “data storage system”) 1008, which may include one or more non-volatile storage devices and/or one or more volatile storage devices. In embodiments where PC 1002 includes a programmable processor, a computer readable storage medium (CRSM) QQ342 may be provided. CRSM QQ342 may store a computer program (CP) 1043 comprising computer readable instructions (CRI) 1044. CRSM 1042 may be a non-transitory computer readable medium, such as, magnetic media (e.g., a hard disk), optical media, memory devices (e.g., random access memory, flash memory), and the like. In some embodiments, the CRI 1044 of computer program 1043 is configured such that when executed by PC 1002, the CRI causes UE 102 to perform steps described herein (e.g., steps described herein with reference to the flow charts). In other embodiments, UE 102 may be configured to perform steps described herein without the need for code. That is, for example, PC 1002 may consist merely of one or more ASICs. Hence, the features of the embodiments described herein may be implemented in hardware and/or software.

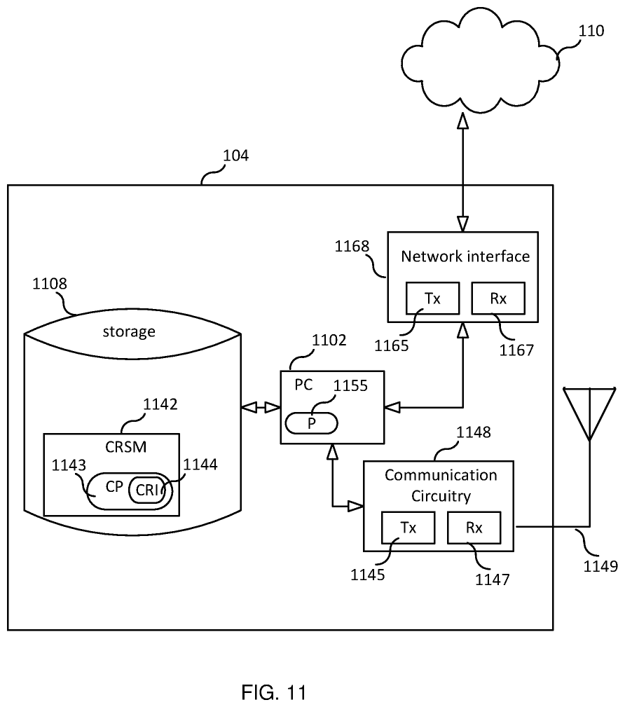

FIG. 11 is a block diagram of base station 104, according to some embodiments for performing the base station methods disclosed herein. As shown in FIG. 11, base station 104 may comprise: processing circuitry (PC) 1102, which may include one or more processors (P) 1155 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., base station may be a distributed computing apparatus); a network interface 1168 comprising a transmitter (Tx) 1165 and a receiver (Rx) 1167 for enabling base station 104 to transmit data to and receive data from other nodes connected to a network 110 (e.g., an Internet Protocol (IP) network) to which network interface 1168 is connected; communication circuitry 1148 (e.g., radio transceiver circuitry comprising an Rx 1147 and a Tx 1145) coupled to an antenna system 1149 for wireless communication with UEs or other nodes; and a storage unit (a.k.a., “data storage system”) 1108, which may include one or more non-volatile storage devices and/or one or more volatile storage devices. In embodiments where PC 1102 includes a programmable processor, a computer readable storage medium (CRSM) 1142 may be provided. CRSM 1142 may store a computer program (CP) 1143 comprising computer readable instructions (CRI) 1144. CRSM 1142 may be a non-transitory computer readable medium, such as, magnetic media (e.g., a hard disk), optical media, memory devices (e.g., random access memory, flash memory), and the like. In some embodiments, the CRI 1144 of computer program 1143 is configured such that when executed by PC 1102, the CRI causes base station 104 to perform steps described herein (e.g., steps described herein with reference to one or more flow charts). In other embodiments, base station 104 may be configured to perform steps described herein without the need for code. That is, for example, PC 1102 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a user equipment (UE), the method comprising:
receiving first sounding reference signal (SRS) configuration information (SRS-CI), the first SRS-CI comprising: first SRS resource information (SRS-RI), associated with a first beam and second SRS-RI associated with a second beam, wherein the first SRS-RI specifies a first periodicity and the second SRS-RI specifies a second periodicity that is longer than the first periodicity;
transmitting to a serving base station a first plurality of SRSs in accordance with the first periodicity specified by the first SRS-RI; and
transmitting to the serving base station a second plurality of SRSs in accordance with the second periodicity specified by the second SRS-RI.

2-10. (canceled)

11. A method performed by a base station, the method comprising:
transmitting to a first user equipment (UE), first sounding reference signal (SRS) configuration information (SRS-CI), the first SRS-CI comprising: first SRS resource information (SRS-RI) associated with a first beam and second SRS-RI associated with a second beam, wherein the first SRS-RI specifies a first periodicity and the second SRS-RI specifies a second periodicity that is longer than the first periodicity;
receiving a first plurality of SRSs transmitted by the first UE in accordance with the first periodicity specified by the first SRS-RI; and
receiving a second plurality of SRSs transmitted by the first UE in accordance with the second periodicity specified by the second SRS-RI.

12. The method of claim 11, wherein transmitting the first SRS-CI to the first UE comprises:
transmitting to the first UE a control message that comprises the first SRS-CI.

13. The method of claim 12, wherein
the control message further comprises second SRS-CI, the second SRS-CI comprising: third SRS-RI associated with the first beam and fourth SRS-RI associated with the second beam, wherein the third SRS-RI specifies a third periodicity that is equal to the second periodicity and the fourth SRS-RI specifies the fourth periodicity that is equal to the first periodicity,
the first SRS-CI specifies that the first SRS-RI is included in a first SRS resource set,
the first SRS-CI specifies that the second SRS-RI is included in a second SRS resource set,
the second SRS-CI specifies that the third SRS-RI is included in a third SRS resource set, and
the second SRS-CI specifies that the fourth SRS-RI is included in a fourth SRS resource set.

14. The method of claim 13, further comprising:
after receiving the second plurality of SRSs transmitted by the first UE in accordance with the second periodicity specified by the second SRS-RI, selecting the second beam to be a serving beam for the first UE; and
as a result of selecting the second beam to be the serving beam for the first UE:
i) triggering the first UE to transmit SRSs in accordance with the third SRS-RI by transmitting to the first UE a first command message that includes an SRS resource set identifier that identifies the third SRS resource set; and
ii) triggering the first UE to transmit SRSs in accordance with the fourth SRS-RI by transmitting to the first UE a second command message that includes an SRS resource set identifier that identifies the fourth SRS resource set.

15. The method of claim 13, further comprising:
transmitting to a second UE the second SRS-CI;
receiving a third plurality of SRSs transmitted by the second UE in accordance with the third periodicity specified by the third SRS-RI; and
receiving a fourth plurality of SRSs transmitted by the second UE in accordance with the fourth periodicity specified by the fourth SRS-RI.

16. A method performed by a base station, the method comprising:
during a first period of time, transmitting to a first user equipment (UE), at least a first number (N1) of command messages, wherein each one of the N1 command messages triggers the UE to transmit a sounding reference signal (SRS) using a resource associated with a first beam; and
during said first period of time, transmitting to the first UE, not more than a second number (N2) of command messages, wherein each one of the N2 command messages triggers the UE to transmit an SRS using a resource associated with a second beam, wherein
N1>N2.

17. The method of claim 16, wherein
at least one of the N1 or N2 command messages is a Media Access Control (MAC) Control Element (MAC-CE) message, or
at least one of the N1 or N2 command messages is Downlink Control Information (DCI) message.

18-20. (canceled)

21. A user equipment (UE), the UE being configured to:
receive first sounding reference signal (SRS) configuration information, SRS-CI, the first SRS-CI comprising: first SRS resource information (SRS-RI) associated with a first beam and second SRS-RI associated with a second beam, wherein the first SRS-RI specifies a first periodicity and the second SRS-RI specifies a second periodicity that is longer than the first periodicity;
transmit to a serving base station a first plurality of SRSs in accordance with the first periodicity specified by the first SRS-RI; and
transmit to the serving base station a second plurality of SRSs in accordance with the second periodicity specified by the second SRS-RI.

22. The UE of claim 21, wherein
the first beam is a serving beam, and
the second beam is a candidate beam.

23. The UE of claim 21, wherein
the first SRC-CI further comprises a third SRS-RI associated with a third beam, and
the third SRS-RI specifies a third periodicity.

24. The UE of claim 23, wherein the third periodicity is longer than the first periodicity.

25. The UE of claim 24, wherein the third periodicity is equal to the second periodicity.

26. The UE of claim 21, wherein the second periodicity is a function of a probability that the UE will move to within a coverage of the second beam.

27. The UE of claim 21, wherein the second periodicity is a function of a measurement of an SRS transmitted by the UE and received by the serving base station using the second beam.

28. The UE of claim 21, wherein
the first SRS-CI specifies that the first SRS-RI is included in a first SRS resource set,
the first SRS-CI specifies that the second SRS-RI is included in a second SRS resource set, and
the UE is configured to transmit the first plurality of SRSs in accordance with the first periodicity specified by the first SRS-RI as a result of receiving a first command message identifying the first SRS resource set; and
the UE is configured to transmit the second plurality of SRSs in accordance with the second periodicity specified by the second SRS-RI as a result of receiving a second command message identifying the second SRS resource set.

29. The UE of claim 28, further being configured to receive second SRS-CI, the second SRS-CI comprising: third SRS-RI associated with the first beam and fourth SRS-RI associated with the second beam, wherein the third SRS-RI specifies a third periodicity and the fourth SRS-RI specifies a fourth periodicity that is shorter than the third periodicity, and wherein
the second SRS-CI specifies that the third SRS-RI is included in a third SRS resource set and the fourth SRS-RI is included in a fourth SRS resource set.

30. The UE of claim 29, wherein
the UE is configured to transmit a third plurality of SRSs in accordance with the third periodicity specified by the third SRS-RI as a result of receiving a third command message identifying the third SRS resource set, and
the UE is configured to transmit a fourth plurality of SRSs in accordance with the fourth periodicity specified by the fourth SRS-RI as a result of receiving a fourth command message identifying the fourth SRS resource set.

31-37. (canceled)
